(19) United States
(12) Patent Application Publication
(10) Pub. No.: US 2011/0314192 A1
(43) Pub. Date: Dec. 22, 2011

(54) UPnP CONTROL POINT FOR SEARCHING UPnP DEVICE BASED ON THE LOCATION AND SEARCHING METHOD USING THE SAME

(75) Inventors: Sang Chul AHN, Seoul (KR); Yong-Moo KWON, Seoul (KR); Kiwoong LIM, Gyeongsangbuk-do (KR)

(73) Assignee: KOREA INSTITUTE OF SCIENCE AND TECHNOLOGY, Seoul (KR)

(21) Appl. No.: 12/845,163

(22) Filed: Jul. 28, 2010

(30) Foreign Application Priority Data
Jun. 16, 2010 (KR) 10-2010-0057200

(51) Int. Cl. G06F 13/12

(52) U.S. Cl. 710/63

(57) ABSTRACT

A UPnP control point for searching a UPnP device based on the location, includes a communication unit that performs communications with UPnP devices on a UPnP network; a memory unit that parses an extensible markup language (XML) description file of a UPnP device, received through the communication unit, and stores UPnP device information containing location information of the UPnP device as a list; and a control unit that provides the stored location information of the UPnP device using location information of the memory unit and generates a control command for a UPnP device selected by a user.

### CROSS-REFERENCE TO RELATED APPLICATION

This application claims priority from and the benefit of Korean Patent Application No. 10-2010-0057200, filed on Jun. 16, 2010, which is hereby incorporated by reference for all purposes as if fully set forth herein.

### BACKGROUND

1. Field of the Invention

Disclosed herein are a universal plug and play (UPnP) control point for searching and controlling a UPnP device most suitable for a user's purpose using location information from UPnP devices searched on a UPnP network, and a searching method of a UPnP device using the UPnP control point.

2. Description of the Related Art

Universal plug and play (UPnP) technology is a technology that enables information appliances connected on a network to communicate with each other without a complicated configuration procedure. The UPnP technology allows one appliance to automatically detect services provided by other appliances. In the UPnP technology, if a user allows an appliance to be connected to a network, appliances previously connected to the network automatically detect and control the newly added appliance.

UPnP is a middleware architecture that allows several devices to be connected in a peer-to-peer fashion. The UPnP allows command and control to be performed between devices on a network, independently of specific operating systems, programming languages and media. The UPnP uses existing protocols such as internet protocol (IP), transmission control protocol (TCP), user datagram protocol (UDP), hypertext transfer protocol (HTTP) and extensible markup language (XML). Data exchanged between devices are expressed using the XML and communicated using the HTTP. Non-IP networks can be connected through bridges.

### SUMMARY OF THE INVENTION

Disclosed herein are a universal plug and play (UPnP) control point for searching and controlling a UPnP device most suitable for a user's purpose using location information included in an extensible markup language (XML) file from UPnP devices on a UPnP network, and a searching method of a UPnP device using the UPnP control point.

In one embodiment, there is provided a UPnP control point for searching a UPnP device based on the location, the UPnP control point including: a communication unit that performs communications with UPnP devices on a UPnP network; a memory unit that parses an extensible markup language (XML) description file of a UPnP device, received through the communication unit, and stores UPnP device information containing location information of the UPnP device as a list; and a control unit that provides the stored location information of the UPnP device using location information of the memory unit and generates a control command for a UPnP device selected by a user.

The UPnP control point may further include an input unit through which location information of the UPnP control point is inputted. The control unit may indicate the location information of the UPnP device in a coordinate system in which the location information of the UPnP control point is a reference point, and provide the indicated location information of the UPnP device.

The UPnP control point may further include a search unit that searches a UPnP device with the same IP as the UPnP control point from the memory unit. The input unit may receive location information of the UPnP device, searched by the search unit, as the location information of the UPnP control point.

The UPnP control point may further include a localization sensor that generates a localization signal for the location of the UPnP control point. The input unit may receive the location information of the UPnP control point from the localization sensor.

In one embodiment, there is provided a searching method of a UPnP device based on the location using a UPnP control point, the method including: receiving an XML description file of an UPnP device from UPnP devices on a UPnP network; parsing the received XML description file of the UPnP device and storing UPnP device information containing location information of the UPnP device as a list; providing the UPnP device information stored as the list.

The method may further include inputting the location information of the UPnP control point. The providing of the UPnP device information may indicate the location information of the UPnP device in a coordinate system in which the location information of the UPnP control point is a reference point, and provide the indicated location information of the UPnP device.

### BRIEF DESCRIPTION OF THE DRAWINGS

The above and other aspects, features and advantages disclosed herein will become apparent from the following description of preferred embodiments given in conjunction with the accompanying drawings, in which:

FIG. 1 is a configuration view of a universal plug and play (UPnP) control point for searching a UPnP device based on the location according to an embodiment;

FIG. 2 is a flowchart illustrating a searching method of a UPnP device based on the location using a UPnP control point according to an embodiment;

FIG. 3 is a view showing an M-SEARCH message transmitted by a UPnP control point to search a UPnP device according to an embodiment; and

FIG. 4 is a view showing an extensible markup language (XML) description file received by a UPnP control point according to an embodiment.

### DETAILED DESCRIPTION OF THE INVENTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

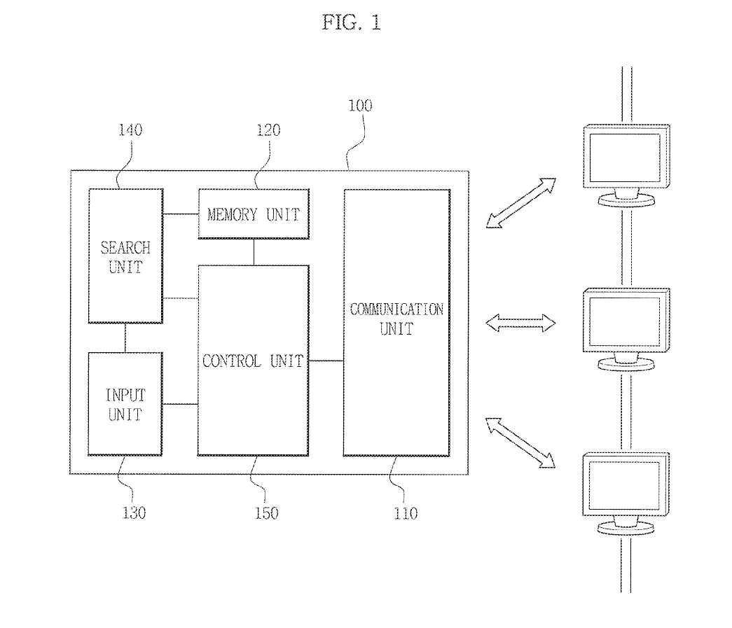

FIG. 1 is a configuration view of a universal plug and play (UPnP) control point for searching a UPnP device based on the location according to an embodiment.

Referring to FIG. 1, the UPnP control point 100 includes a communication unit 110, a memory unit 120, an input unit 130, a search unit 140 and a control unit 150.

The communication unit 110 performs communications with a UPnP device on a UPnP network. The UPnP control point 100 may be a UPnP general control point that can control all UPnP devices connected to the UPnP network. The UPnP control point 100 may communicate a message with the UPnP devices on the UPnP network through the communication unit 110 by using a UDP/IP or TCP/IP transmission scheme. The UPnP control point 100 may transmit/receive a message through the communication unit 110 by a simple service discovery protocol (SSDP). That is, in order to obtain information of all the UPnP devices on the UPnP network, the UPnP control point 100 transmits an M-SEARCH message in which a search target is defined as ssdp:all through the communication unit 110 so as to obtain a uniform resource locators (URL) of a webserver, in which an extensible markup language (XML) description file of the UPnP device exists, from the all the UPnP devices on the UPnP network. Thus, the UPnP control point 100 can receive the XML description file of the UPnP device, in which UPnP device information is contained, from the URL of the webserver.

The memory unit 120 parses the XML description file of the UPnP device, received through the communication unit 110 and then stores the parsed XML description file as a list. The XML description file of the UPnP device contains the information on the UPnP device. For example, the information on the UPnP device may contain various pieces of manufacturing information including a device type, a friendly name, a manufacturer, a unique device name (UDN), device model information, and the like. The XML description file of the UPnP device may further contain physical location information of the UPnP device. The location information of the UPnP device may be indicated suitable for the XML grammar rules based on the XML standard. For example, the location information of the UPnP device may be indicated as the name, floor and room number of the building in which the UPnP device is located or location information in a three-dimensional coordinate system. The location information in the three-dimensional coordinate system may be indicated as a unit of centimeter (cm) or the like in a coordinate system such as XYZ. The UPnP control point 100 obtains the information on the UPnP device, contained in the XML information of the UPnP device, and stores the obtained information as the form of a list in the memory unit 120.

The location information of the UPnP control point 100 is inputted through the input unit 130. The location information of the UPnP control point 100 may be directly inputted by a user, or may be obtained and inputted by the UPnP control point 100. In the method that the UPnP control point 100 obtains its own location information by itself, a UPnP device with the same IP as the UPnP control point 100 among UPnP devices searched using the UPnP technology in the interior of the UPnP control point 100 is determined as an internal device, so that the location of the UPnP device with the same IP as the UPnP control point 100 can be obtained as its own location information. The location information of the UPnP control point 100 may be obtained from a localization sensor that is built in the UPnP control point 100 or built in the environment at which the UPnP control point 100 is located. The localization sensor may obtain location information by using a camera, by using a relative distance through a radio frequency (RF) signal, by using a marker, and the like.

In order to obtain the location information of the UPnP control point 100, the search unit 140 searches a UPnP device with the same IP as the UPnP control point 100 from the UPnP device list of the memory unit 120 and transmits the location information of the searched UPnP device to the input unit 130.

The control unit 150 provides the location information of the respective UPnP devices stored as the list of the memory unit 120, and generates a control command to control a UPnP device selected by a user. Thus, the control unit 150 transmits a simple object access protocol (SOAP) to the selected UPnP device. If the location information of the UPnP control point 100 is inputted to the UPnP control point 100, the control unit 150 may provide additional information in which the location information of the UPnP device is indicated in the coordinate system, in which the location information of the UPnP control point is a reference point, based on the location information of the UPnP control point 100. Through the aforementioned process, the user receives the location information of the UPnP devices on the UPnP network from the UPnP control point 100. Thus, the user can select a UPnP device that exists at the closest location or at a specific location. Since the connection states of the UPnP devices connected on the UPnP network may be changed depending on time, the UPnP control point 100 searches the UPnP devices for every predetermined period so as to update the UPnP device information stored in the memory unit 120.

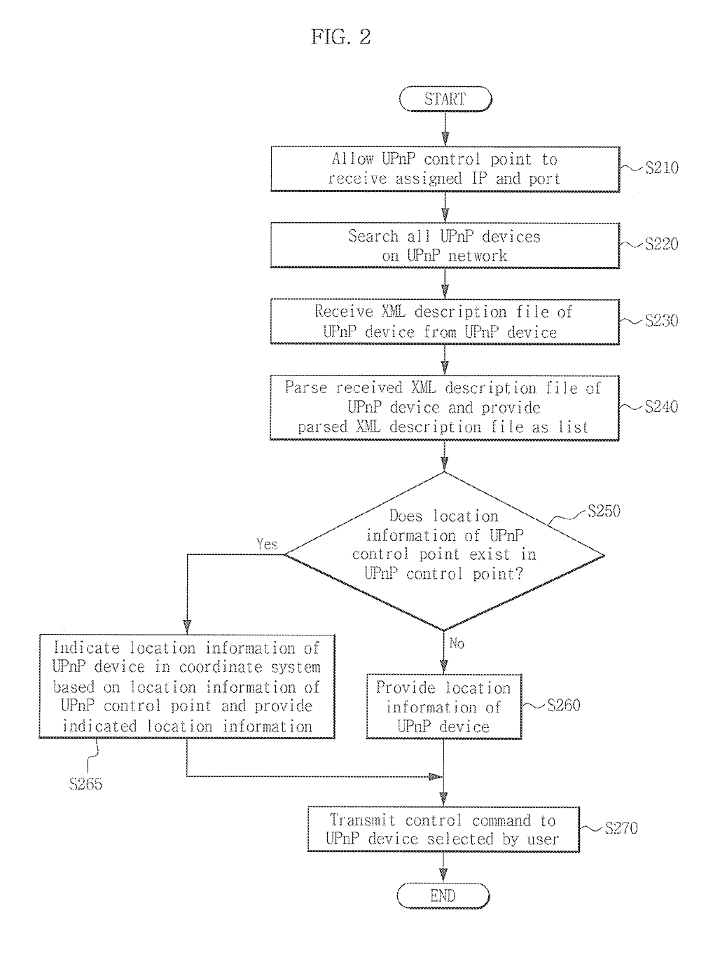

FIG. 2 is a flowchart illustrating a searching method of a UPnP device based on the location using a UPnP control point according to an embodiment.

Referring to FIG. 2, the UPnP control point receives its own IP and port assigned through UPnP addressing (S210) and transmits an M-SEARCH message in which a search target is defined as ssdp:all, thereby searching all UPnP devices on the a UPnP network (S220). Subsequently, the UPnP control point receives a response message corresponding to the M-SEACH from a UPnP device and obtains the URL of a webserver, in which an XML description file of the UPnP device exists, thereby receiving the XML description file of the UPnP device (S230). The UPnP control point parses the received XML description file and stores the parsed XML description file as a list (S240). Subsequently, the UPnP control point determines whether or not its own location information exists in the UPnP control point (S250). When it is determined that its own location information does not exist in the UPnP control point, UPnP device information contained in the XML description file is provided (S260). If its own location information exists in the UPnP control point, the location information of the UPnP device, contained in the XML description file, is indicated in a coordinate system in which the location information of the UPnP control point is a reference point, thereby providing the indicated location information of the UPnP control point as additional information (S265). If a selection signal for a UPnP device is inputted by a user, the UPnP control point transmits a control command to the selected UPnP device (S270).

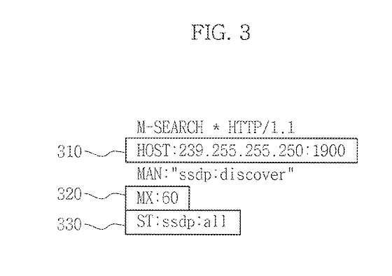

FIG. 3 is a view showing an M-SEARCH message transmitted by a UPnP control point to search a UPnP device according to an embodiment.

Referring to FIG. 3, the M-SEARCH message is transmitted to the UPnP device using the UDP/IP transmission scheme. The M-SEARCH message uses a host 130 of 239.255.225.250:1900 310, and the time for waiting for a response message from the UPnP device is set to be 60 seconds 320. In the M-SEARCH message, a search target (ST) is set as ssdp:all 330 so as to search all UPnP devices on the UPnP network.

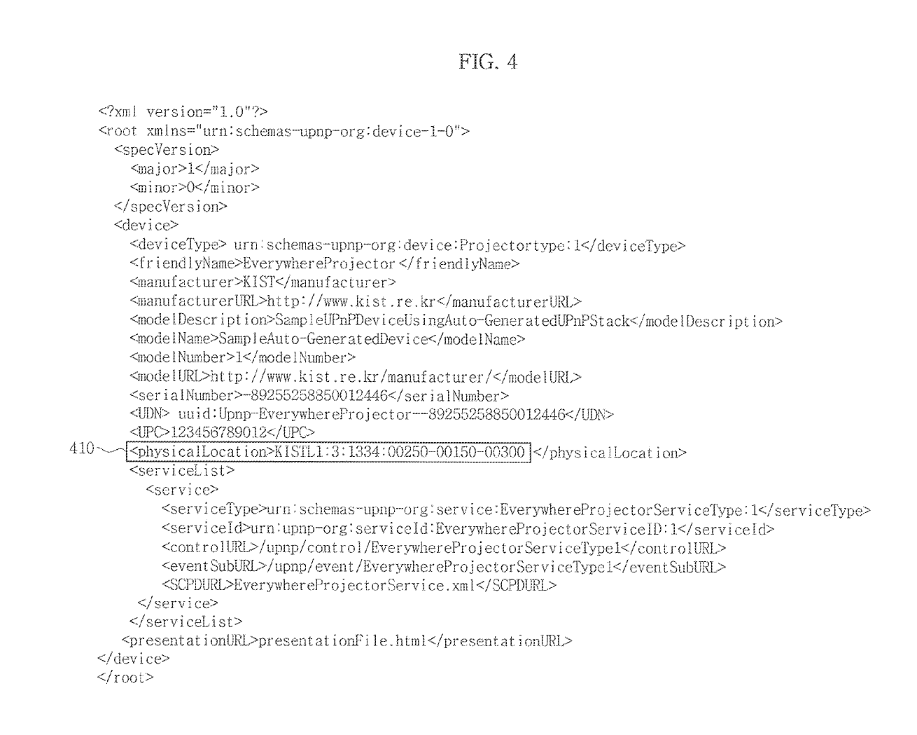

FIG. 4 is a view showing an XML description file received by a UPnP control point according to an embodiment.

Referring to FIG. 4, various pieces of information including a device type, a friendly name, a unique device name (UDN) and the like are contained in the XML description file of the UPnP device. In the XML description file shown in FIG. 4, the friendly name of the UPnP device is “EverywhereProjector,” and the manufacturer of the UPnP device is “KIST.” A location information item 410 of the UPnP device, represented as “physicalLocation” is further included in the XML description file of the UPnP device. The location information item 410 of the UPnP device includes the name, floor and room number of the building in which the UPnP device is located, and the location in the XYZ coordinate system as a unit of centimeter (cm), based on the XML standard. That is, the XML description file of the FIG. 4 indicates that the UPnP device is located at room “1334” on “3” floor in building “KIST1” and is a projector located at a point that is “250 cm on X-axis,” “150 cm on Y-axis,” and “300 cm on Z-axis” from the reference point. The location information of the UPnP device, indicated as described above, allows a user to select a UPnP device that exists at the closest location or a specific location.

In the UPnP control point for searching a UPnP device based on the location and the searching method of a UPnP device using the same, the configurations and methods of the aforementioned embodiments are restrictively applied, but may be configured by selectively combining the whole or part of the embodiments so that various modifications can be made.

It is highly likely that many sensors and smart devices having similar functions and names will coexist in the ubiquitous computing environment and that the UPnP technology will be applied to smart devices and electric appliances in the further. The UPnP technology can automatically discover a UPnP device based on a friendly name by using the SSDP and obtain information of the UPnP device by receiving a XML description file of the UPnP device from the UPnP device. However, as described above, it is highly likely that many devices having similar functions and names will coexist in the ubiquitous computing environment. Therefore, it is required to propose a technology for searching a UPnP device that exists at the closest location or a specific location.

In the proposed technology, location information is provided by adding tag <physicalLocation> to an XML description file of a UPnP device, so that it is possible to search a more suitable UPnP device on the UPnP network. If the technology is applied to mobile devices such as mobile phones or PDAs, a device available at its own location can be easily identified and controlled.

As described above, in a UPnP control point and a searching method of a UPnP device based on the location using the UPnP control point according to embodiments, location information of a UPnP device can be easily obtained in the ubiquitous computing environment in which the states of UPnP devices are changed on occasion, and the UPnP control point can search and control the optimal UPnP device by using the location information of the UPnP device.

While the disclosure has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A universal plug and play (UPnP) control point for searching a UPnP device based on the location, the UPnP control point comprising:
a communication unit that performs communications with UPnP devices on a UPnP network;
a memory unit that parses an extensible markup language (XML) description file of a UPnP device, received through the communication unit, and stores UPnP device information containing location information of the UPnP device as a list; and
a control unit that provides the stored location information of the UPnP device using location information of the memory unit and generates a control command for a UPnP device selected by a user.

2. The UPnP control point according to claim 1, further comprising an input unit through which location information of the UPnP control point is inputted,
wherein the control unit indicates the location information of the UPnP device in a coordinate system in which the location information of the UPnP control point is a reference point, and provides the indicated location information of the UPnP device.

3. The UPnP control point according to claim 2, further comprising a search unit that searches a UPnP device with the same IP as the UPnP control point from the memory unit,
wherein the input unit receives location information of the UPnP device, searched by the search unit, as the location information of the UPnP control point.

4. The UPnP control point according to claim 2, further comprising a localization sensor that generates a localization signal for the location of the UPnP control point,
wherein the input unit receives the location information of the UPnP control point from the localization sensor.

5. The UPnP control point according to claim 4, wherein the localization sensor generates the localization signal for the location of the UPnP control point by using a camera.

6. The UPnP control point according to claim 4, wherein the localization sensor generates the localization signal for the location of the UPnP control point by using a relative distance through a radio frequency (RF) signal.

7. The UPnP control point according to claim 4, wherein the localization sensor generates the localization signal for the location of the UPnP control point by using a marker.

8. The UPnP control point according to claim 1, wherein the location information of the UPnP device contains space information based on the XML standard.

9. The UPnP control point according to claim 8, wherein the space information contains location information for an arbitrary space in a three-dimensional coordinate system.

10. A searching method of a UPnP device based on the location using a UPnP control point, the method comprising:
receiving an XML description file of an UPnP device from UPnP devices on a UPnP network;
parsing the received XML description file of the UPnP device and storing UPnP device information containing location information of the UPnP device as a list;
providing the UPnP device information stored as the list.

11. The method according to claim 10, further comprising inputting the location information of the UPnP control point,
wherein the providing of the UPnP device information indicates the location information of the UPnP device in a coordinate system in which the location information of the UPnP control point is a reference point, and provides the indicated location information of the UPnP device.
